(19) United States
(12) Patent Application Publication
(10) Pub. No.: US 2007/0168251 A1
(43) Pub. Date: Jul. 19, 2007

(54) Method and apparatus for a promotional couponing system

(76) Inventors: John J. Hilbert, Torrance, CA (US); Benjamin Cao, Santa Fe Springs, CA (US)

Correspondence Address: FITZPATRICK CELLA HARPER & SCINTO, 30 ROCKEFELLER PLAZA, NEW YORK, NY, 10112, US

(21) Appl. No.: 11/502,888

(22) Filed: Aug. 10, 2006

Related U.S. Application Data
(60) Provisional application No. 60/707,378, filed on Aug. 10, 2005.

(51) Int. Cl. G07G 1/14

(52) U.S. Cl. 705/14

(57) ABSTRACT

A system is provided for the creation and management of promotional coupons or vouchers using coupon templates written in a template definition language, promotions, and promotional campaigns for the generation and issuance of promotional coupons either in real time or based on a predetermined date and/or time by a printer for use in a gaming, vending, or other business environment. The system uses a host system and a graphical front-end to a template definition language. Promotional coupons include coupons for merchandise, food, beverages, parking, lodging, special events such as a boxing or a tournament, personal events such as a birthday or an anniversary, entertainment, and a free play of a game or certain types of games. These promotional coupons can offer a discount, a refund, a rebate, or a free product or service. Promotions include those for a tangible or intangible product, a service, an event, and lodging. Promotional campaigns include those for events such as a holiday, contest, drawing, tournament, and other special events such as boxing.

### CROSS-REFERENCE TO RELATED APPLICATIONS

This application claims the benefit of U.S. Provisional Patent Application No. 60/707,378, filed Aug. 10, 2005, the contents of which are hereby incorporated by reference as if stated in full herein.

### BACKGROUND OF THE INVENTION

This invention relates to a promotional couponing system for the creation and management of promotional coupons, promotions, and promotional campaigns using a host system and a graphical front-end to a template definition language for the generation and issuance of promotional coupons either in real time or based on a predetermined date and/or time by a printer for use in a gaming, vending, or other business environment.

Gaming machine manufacturers have introduced cashless enabled gaming machines to the market and these have begun to find wide acceptance in the gaming industry. Cashless enabled gaming machines are so named because they can conduct financial exchanges using a mixture of traditional currencies and vouchers. Typically, a cashless enabled gaming machine has a gaming printer to produce vouchers and a bill acceptor that supports automatic reading of vouchers. To coordinate the activities of multiple cashless enabled gaming machines, one or more cashless enabled gaming machines may be electronically coupled to a cashless enabled gaming machine system that controls the cashless operations of a cashless enabled gaming machine.

Cashless enabled gaming machines have found increasing acceptance and use in the gaming industry with players who enjoy the speed of play and ease of transporting their winnings around a gaming establishment and the gaming establishments who have realized significant labor savings in the form of reduced coin hopper reloads in the games, and an increase in revenue because of the speed of play. Gaming and vending machine manufacturers have increasingly added additional printing features to their gaming and vending machines. One of these features is the ability to create promotional coupons from the vending machines. However, there is no method or system in place to create, issue, and manage promotional coupons, promotions, or promotional campaigns which may be transmitted to, stored in, and used by a printer.

Promotional coupon generation and issuance can include a system which edits the layout of a coupon template. While this method may allow a user to design coupons, it does not allow the association of coupons to one or more promotions or the association of one or more promotions to a promotional campaign. Another problem with this method is the inability to copy coupon print regions from one coupon template to another template.

Promotional coupon generation and issuance can also include the direct mailing of coupons from a gaming or other business establishment to consumers. One problem that plagues this method is that the promotion must be planned well in advance to accommodate the printing and mailing of the promotional coupons to consumers. Another problem is direct mailing and printing is not cost effective. Another problem is that the preprinted promotional coupons cannot be directly inserted into or read by a bill acceptor in a gaming or vending machine. The preprinted promotional coupons must be processed by hand, the process which lends itself to fraud and security issues such as forgery.

Promotional coupon generation and issuance can also include providing consumers the means to download promotions from a networked environment (typically the Internet) for a gaming or other business establishment. In addition to some of the problems cited for the previously described existing methods, problems for this existing method also include the lack of the consumer's presence at a gaming or other business establishment which reduces the promotion's overall effectiveness and coupon redemption.

In a method related to the generation and issuance of promotional coupons, comps can be issued by a gaming establishment to a consumer. Comps can include free meals, drinks, show tickets, special room rates, room upgrades, match play coupons, and free cash. One problem with this method is that the comp is usually processed or issued by a cashier, pit boss, or floor person whereby it must be determined if the consumer should receive a comp.

Therefore, gaming establishments and vendors use multiple promotion methods to induce individuals to patronize the gaming establishment or associated gaming establishments or other types of establishments. However, there is no method or system in place to create, issue, and manage promotional coupons, promotions, and promotional campaigns which may be transmitted to, stored in, and used by a printer already installed within a cashless enabled gaming machine system. There exists a need, therefore, to provide a way to create, issue, and manage promotional coupons, promotions, and promotional campaigns. Various systems in accordance with exemplary embodiments of the present invention meet such a need.

### SUMMARY OF THE INVENTION

In one example situation, a restaurant opens down the street from a movie theatre. The movie theatre, equipped with a kiosk or multiple kiosks, each coupled to a printer, can issue movie tickets directly to a consumer. The restaurant wants to promote their business by offering customers of the movie theatre a buy-one-get-one-free dinner. The restaurant pays the movie theatre to advertise this promotion using promotional coupons generated from each printer in each kiosk at the movie theatre. The movie theatre or the restaurant creates a promotional coupon for the restaurant using a system in accordance with an exemplary embodiment of the present invention described herein. In addition, parameters for the promotion such as start and end date and time are set. The data for the promotional coupon is then saved on a host system and sent to a printer in each kiosk at the movie theatre. Based on the criteria set up for the promotion, a consumer can receive the promotional coupon for the restaurant when the consumer, for example, purchases a movie ticket from a kiosk at the movie theatre.

In another example situation, a gaming establishment desires to create a promotion for a new cashless enabled slot machine by offering match play coupons. Using a system in accordance with an exemplary embodiment of the present invention described herein, a gaming establishment can create a promotional coupon for the match play promotion. Parameters for the promotion such as start and end date and time, and number of coupons to issue are set. The data for the match play promotional coupon is saved on a host system and sent to a printer in one or more cashless enabled gaming machines. After a consumer plays and cashes out of a cashless enabled gaming machine, and if the criteria set for the promotion is met, the consumer receives the match play promotional coupon. The consumer can then play the new cashless enabled slot machine using the match play promotional coupon by inserting the match play promotional coupon into the bill acceptor of the new cashless enabled slot machine.

In another aspect of a system in accordance with an exemplary embodiment of the present invention, a user can create promotional coupons, promotions, and promotional campaigns in real time, thereby allowing up-to-the-minute or last-minute implementations. For example, a gaming establishment desires to create a last-minute promotion to issue a promotional coupon to consumers who have played for more than two consecutive hours on the same gaming machine. Using a system in accordance with an exemplary embodiment of the present invention described herein, the gaming establishment creates the promotional coupon template and the promotion. The data for the promotional coupon and promotion is saved on the host system and sent to a printer in one or more cashless enabled gaming machines. If the criteria set for the promotion is met, the printer then issues the promotional coupon to a consumer who plays for more than two consecutive hours on the same gaming machine.

These and other advantages can be realized by various systems in accordance with exemplary embodiments of the present invention. In one aspect, a system in accordance with an exemplary embodiment of the present invention defines coupon templates written in a template definition language, promotions, and promotional campaigns for the creation and management of promotional coupons, promotions, and promotional campaigns using a host system and a graphical front-end to a template definition language for the generation and issuance of promotional coupons in real time or based on a predetermined criteria, such as a predetermined date and/or time by a printer, for use in a gaming, vending, or other business environment.

Promotional coupons include coupons for merchandise, food, beverages, parking, lodging, special events such as a boxing or a tournament, personal events such as a birthday or an anniversary, entertainment, and a free play of a game or certain types of games. These promotional coupons can offer a discount, a refund, a rebate, or a free product or service.

Promotions include those for a tangible or intangible product, a service, an event, and lodging. Promotional campaigns include those for events such as a holiday, contest, drawing, tournament, and other special events such as boxing.

In one system in accordance with an exemplary embodiment of the present invention, when a gaming or other business establishment desires to define a promotional coupon, the promotional coupon template where the layout and print regions of text, graphics, barcodes, lines, and boxes are defined as displays. A gaming or other business establishment defines the layout of a promotional coupon template by placing print regions on the promotional coupon template. For example, the user desires to place a barcode as a print region on the promotional coupon template. The user selects the barcode option to define the parameters for that barcode. The parameters include, for example, region ID, region data, region size, object ID, object rotation, object width, object justification, object attributes, print attributes, and print color among others. These parameters are also used to modify a print region.

The user can move any region to another area on a promotional coupon template, place a region in front of other regions, or place a region behind other regions.

Furthermore, one system in accordance with an exemplary embodiment of the present invention allows multiple promotional coupon templates to be created based on existing promotional coupon templates. In this system, a gaming or other business establishment selects an existing promotional coupon template on which additional promotional coupon templates are based. Each additional promotional coupon template inherits the characteristics of the selected existing promotional coupon template but can be separately modified. Using the promotional coupon template editor which displays, a gaming or other business establishment can create a new promotional coupon template, delete a selected promotional coupon template, and display or hide print regions on a promotional coupon template.

Another system in accordance with an exemplary embodiment of the present invention allows the user to adjust the workspace for structuring the promotional coupon template. Thus, if desired, the user can zoom in on the overall layout and print regions of a promotional coupon template to closely view and modify the overall layout and print regions. This feature also permits users to zoom out to view the overall layout and print regions of a promotional coupon template.

After the gaming or other business establishment defines the print regions for the promotional coupon template, the promotional coupon template is stored in a document. The document contains multiple lines. Each line contains a command and the associated parameters required to use that promotional coupon template. The document is stored on a host system and may be incorporated into a new or existing promotion. The data may also be transmitted to, stored in, and used by a printer either alone or with other promotional coupon templates to generate a promotional coupon or a plurality of promotional coupons. The data may also be transmitted to and stored in a routing device coupled to a printer, the routing device transmitting the stored data to the printer to generate a promotional coupon or plurality of such.

Furthermore, one system in accordance with an exemplary embodiment of the present invention allows the overall layout and print regions of a promotional coupon template to be edited or deleted. The parameters for a print region which can be edited include region ID, region data, region size, object ID, object rotation, object width, object justification, object attributes, print attributes, and print color among others.

In another system in accordance with an exemplary embodiment of the present invention, a gaming or other business establishment defines one or a plurality of triggers by which a promotional coupon or promotional coupons may be generated by a printer. These triggers include amount wagered, amount lost, rate of play, length of play, issuance per trigger, birthday, frequency selector, and issue period. Other parameters used to define a promotion include promotion start and end dates, a promotion ending period based on number of issued coupons, promotion start and end times, issuing a name for the promotion, assigning one or a plurality of triggers to the promotion, and selecting one or a plurality of promotional coupon templates for use with the promotion.

The data for a promotion is stored on the host system and may be used in one or a plurality of promotional campaigns. Data created for a promotion or a plurality of promotions may be transmitted to, stored in, and used by a printer to generate one or a plurality of promotional coupons. The data may also be transmitted to and stored in a routing device coupled to a printer, the routing device transmitting the stored data to the printer to generate a promotional coupon or plurality of such.

Furthermore, another system in accordance with an exemplary embodiment of the present invention allows promotions to be edited or deleted. The parameters for a promotion which can be edited include all those previously described.

When a gaming or other business establishment desires to define a promotional campaign, promotions and promotional campaigns are defined as displays. A gaming or other business establishment defines a promotional campaign by associating one or a plurality of predefined promotions to the promotional campaign, assigning a name to the promotional campaign, and selecting a promotional coupon and triggers.

The data for a promotional campaign is stored on the host system. Data created for a promotional campaign may be transmitted to, stored in, and used by a printer to generate one or a plurality of promotional coupons. The data may also be transmitted to and stored in a routing device coupled to a printer, the routing device transmitting the stored data to the printer to generate a promotional coupon or plurality of such.

Furthermore, another system in accordance with an exemplary embodiment of the present invention allows promotional campaigns to be edited or deleted. The parameters for a promotional campaign which can be edited include the promotional campaign name, promotion associations, and type of promotional campaign, among others.

In addition, one system in accordance with an exemplary embodiment of the present invention allows the export of promotional coupon templates and data for promotional coupons, promotions, and promotional campaigns for incorporation and use by external software applications such as a casino management system or player tracking system.

Furthermore, another system in accordance with an exemplary embodiment of the present invention provides various methods of establishing communications with a printer for data transmission. In one aspect of such a system, when a gaming or other business establishment desires to set up the communication port to which data is transmitted to a printer, the communication port settings displays. A gaming or other business establishment selects the communication port and the communication protocol baud rate, identifies the polling option and command, and initializes the communication port. In addition, a gaming or other business establishment can locate additional communication ports to which to establish communications.

In another aspect of a system in accordance with an exemplary embodiment of the present invention, when a gaming or other business establishment desires to set up the respective communication ports to which gaming or vending vouchers and promotional coupon data is transmitted to a printer, the communication ports settings displays. A gaming or other business establishment selects a gaming or vending voucher file, selects the communication port and the communication protocol baud rate, and initializes the communication port for the gaming or vending voucher. A gaming or other business establishment repeats this process for a promotional coupon.

A gaming or other business establishment can also set the delay between print option which sets the delay print time between printing a gaming or vending voucher and printing a promotional coupon. A gaming or other business establishment can also disconnect the communication port for the gaming or vending voucher, the promotional coupon, or both.

When a gaming or other business establishment desires to view the parameters of a print job prior to sending a data to a printer, the print job controls are displayed. A gaming or other business establishment can select options such as manually sending the print job, sending all print jobs without delay, sending all print jobs with delay, canceling a print job, and clearing the output log that is created when a print job is sent to a printer.

A gaming or other business establishment can also view the status of a printer. When desiring to do so, the printer status displays. A gaming or other business establishment can view any communication errors, such as Universal Asynchronous Receiver Transmitter (UART) errors, view the printer library, and reset the printer if necessary.

In another aspect of a system in accordance with an exemplary embodiment of the present invention, data for a promotional campaign which may be transmitted to a printer from a host system, stored in, and used by a printer to generate a promotional coupon or a plurality of promotional coupons, may be combined with data for a promotional coupon or plurality of promotional coupons. In this system, when a gaming or other business establishment desires to create or edit a promotional campaign, promotions and promotional campaigns are defined as displays. After a gaming or other business establishment creates or edits a promotional campaign, the system inserts a header in the promotional campaign data file which identifies the promotional campaign. The system also calculates a signature, such as a CRC, based on the contents of the promotional campaign data and sends the signature to the printer.

In another aspect of a system in accordance with an exemplary embodiment of the present invention, a boundary check on the combined promotional coupon template or plurality of promotional coupon templates, print regions, graphics and other data which may be included with the promotional campaign data may be performed to ensure conformance with the resources and load requirements of the printer. In this system, after a gaming or other business establishment transmits data to a printer, the promotional couponing system performs the boundary check by determining the number of promotional coupon templates, print regions, graphics and other data which may be included with promotional campaign data. The promotional couponing system then verifies the signature. After successful verification of the signature, the promotional couponing system loads the data for each promotional coupon template and sends the signature to the printer.

In another aspect of a system in accordance with an exemplary embodiment of the present invention, data for promotional coupon templates, promotions, and promotional campaigns are stored in the memory of the printer. In this system, the promotional couponing system transmits the data for promotional coupon templates, promotions, and promotional campaigns to a printer or plurality of such. When all parameters of a promotion or a promotional campaign are met, the printer uses the data stored in memory to generate a promotional coupon or a plurality of promotional coupons.

In another aspect of a system in accordance with an exemplary embodiment of the present invention, data for promotional coupon templates, promotions, and promotional campaigns are stored in a routing device coupled to a gaming printer. In this system, the promotional couponing system transmits the data for promotional coupon templates, promotions, and promotional campaigns to the routing device. When all the parameters for a promotion or promotional campaign are met, the routing device transmits the stored data to the gaming printer to generate a promotional coupon or a plurality of promotional coupons.

### BRIEF DESCRIPTION OF THE DRAWINGS

These and other features, aspects, and advantages of the present invention will become better understood with regard to the following description, accompanying drawings and appendix where:

FIG. 1 is a process flow diagram of the promotional couponing system in accordance with an exemplary embodiment of the present invention.

FIG. 2 is an illustration of the attributes of the print regions of a promotional coupon template in accordance with an exemplary embodiment of the present invention.

FIG. 3 is an illustration of a promotional coupon including logical fields in accordance with an exemplary embodiment of the present invention.

FIG. 4 is an illustration of the attributes of the communication settings with a printer in accordance with an exemplary embodiment of the present invention.

FIG. 5 is an illustration of the attributes of the printer settings in accordance with an exemplary embodiment of the present invention.

FIG. 6 is a flow chart of a load, check, and verify CRC process for a promotional campaign in accordance with an exemplary embodiment of the present invention.

FIG. 7 is an illustration of the data stored in the memory of a printer in accordance with an exemplary embodiment of the present invention.

FIG. 8 is a process flow diagram for vouchers and promotional data in a gaming environment in accordance with an exemplary embodiment of the present invention.

FIG. 9 is a block diagram of a printer in accordance with an exemplary embodiment of the present invention.

FIG. 10 is a block diagram of a host for creation of a promotion in accordance with an exemplary embodiment of the present invention.

APPENDIX A is a list of definitions of terms as used herein.

Identically labeled elements appearing in different ones of the figures refer to the same elements but may not be referenced in the description for all figures.

### DETAILED DESCRIPTION

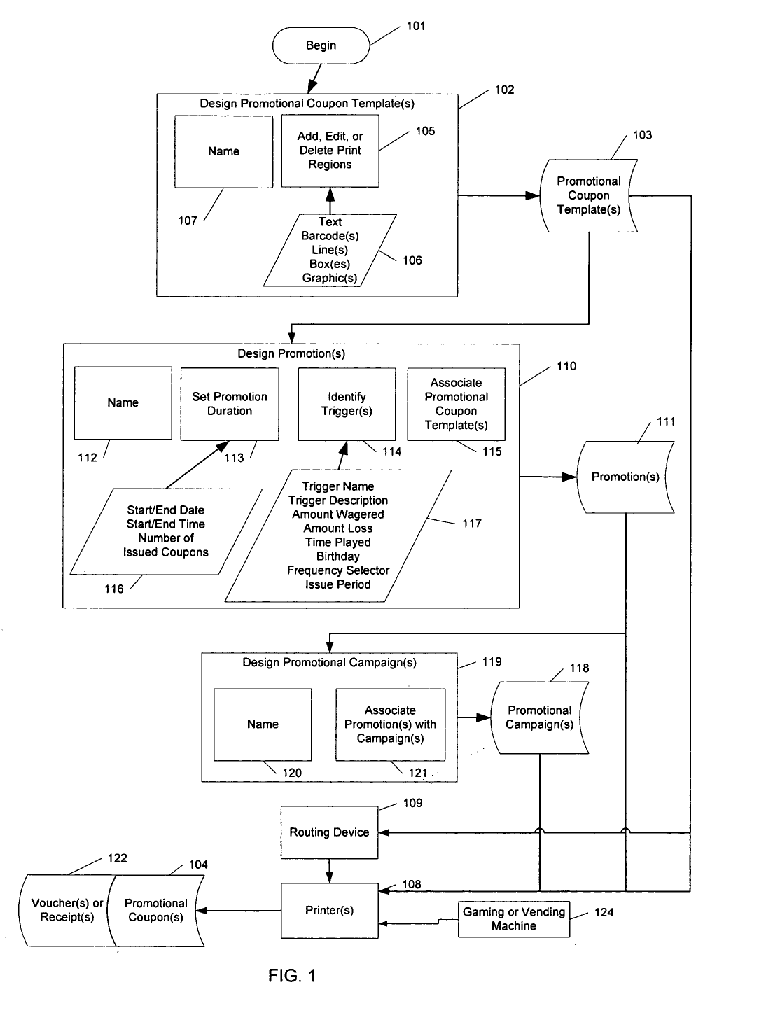

FIG. 1 is a process flow diagram of the promotional couponing system in accordance with an exemplary embodiment of the present invention. As illustrated the process begins (101) when a user uses a user input device (not shown) to design (102) a promotional coupon template 103 which is used to create promotional coupons 104. Print regions can be added, edited, or deleted (105) from promotional coupon template 103. The print regions which may be included on promotional coupon template 103 are text or plurality of text, a barcode or plurality of barcodes, a line or plurality of lines, a graphic or plurality of graphics, and a box or plurality of boxes, as shown in element 106. As promotional coupon template 103 is designed, the appearance of promotional coupons 104 is displayed to the user on a user output device (not shown) such as a screen or other display.

Each promotional coupon template is given (107) a name. The data for promotional coupon template 103 is stored on a host system and may be used in a promotion or a plurality of promotions. The data for each promotional coupon template 103 may also be transmitted to, stored in, and used by a printer 108 or plurality of printers to generate promotional coupon 104 or a plurality of promotional coupons.

The data for each promotional coupon template 103 may also be transmitted to and stored in a routing device 109 or a plurality of routing devices, each which is coupled to a printer, such as printer 108. Routing device 109 transmits the stored data to printer 108 to generate promotional coupon 104 or a plurality of promotional coupons.

If promotional coupon template 103 or plurality of promotional coupon templates is used in a promotion or plurality of promotions, the process continues with the design (110) of a promotion 111 or plurality of promotions. Each promotion 111 is given (112) a name, the promotion duration is set (113), triggers are identified (114), and promotional coupon templates are associated (115). The promotion duration parameters include start and end date, start and end time, and number of issued coupons, among others, as shown in element 116. The triggers include amount wagered, amount loss, time played, birthday, frequency selector, and issue period among others, as shown in element 117. The promotional coupon trigger is given a name and described. The data for each promotion 111 is stored on a host system and may be used in any promotional campaign or plurality of promotional campaigns. The data for each promotion may also be transmitted to printer 108 or plurality of printers to generate promotional coupon 104 or a plurality of promotional coupons.

The data for each promotion may also be transmitted to and stored in routing device 109 or a plurality of routing devices, each which is coupled to a printer, such as printer 108. Routing device 109 transmits the stored data to printer 108 to generate promotional coupon 104 or a plurality of promotional coupons.

If promotion 111 or plurality of promotions is to be used in a promotional campaign 118 or plurality of promotional campaigns, the process continues with the design (119) of a promotional campaign or plurality of promotional campaigns. Each promotional campaign is given (120) a name and a promotion or plurality of promotions is associated (121) with each promotional campaign 118. The data for each promotional campaign 118 is stored on a host system and may be transmitted to printer 108 or a plurality of printers to generate promotional coupon 104 or a plurality of promotional coupons.

The data for each promotional campaign 118 may also be transmitted to and stored in routing device 109 or a plurality of routing devices, each which is coupled to a printer, such as printer 108. Routing device 109 transmits the stored data to printer 108 to generate promotional coupon 104 or a plurality of promotional coupons. In addition, as printer 108 is also coupled to a gaming or vending machine 124, printer 108 may print vouchers 122 along with coupon 104.

In one system in accordance with an exemplary embodiment of the present invention, data for promotional coupon templates, promotions, and promotional campaigns are stored in routing device 109 coupled to printer 108. In this system, the promotional couponing system transmits the data for promotional coupon templates, promotions, and promotional campaigns to routing device 109. When all the parameters for a promotion or promotional campaign are met, the routing device transmits the stored data to printer 108 to generate promotional coupon(s) 104.

In another system in accordance with an exemplary embodiment of the present invention, a user can create promotional coupons 104, promotions, and promotional campaigns in real time, thereby allowing up-to-the-minute or last-minute implementations. Using such a system, the gaming establishment creates the promotional coupon template and the promotion. The data for the promotional coupon and promotion is saved on the host system and sent to printer 108 in one or more cashless enabled gaming machines. If the criteria set for the promotion is met, the printer then issues the promotional coupon to a consumer.

In one system in accordance with an exemplary embodiment of the present invention, coupon templates 101 written in a template definition language, promotions 111, and promotional campaigns 118 are designed using a host system and a graphical front-end to a template definition language.

When a gaming or other business establishment desires to define a promotional coupon, the promotional coupon template where the layout and print regions of text, graphics, barcodes, lines, and boxes are defined as displays. A gaming or other business establishment defines the layout of promotional coupon templates 103 by placing print regions on the promotional coupon template. For example, the user desires to place a barcode as a print region on promotional coupon templates 103. The user selects the barcode option to define the parameters for that barcode. The parameters include, for example, region ID, region data, region size, object ID, object rotation, object width, object justification, object attributes, print attributes, and print color among others. These parameters are also used to modify a print region.

The user can move any region to another area on promotional coupon templates 103, place a region in front of other regions, or place a region behind other regions.

Another system in accordance with an exemplary embodiment of the present invention allows multiple promotional coupon templates 103 to be created based on existing promotional coupon templates. In this system, a gaming or other business establishment selects an existing promotional coupon template on which additional promotional coupon templates 103 are based. Each additional promotional coupon template inherits the characteristics of the selected existing promotional coupon template but can be separately modified. Using the promotional coupon template editor which displays, a gaming or other business establishment can create a new promotional coupon template, delete a selected promotional coupon template, and display or hide print regions on a promotional coupon template.

Another system in accordance with an exemplary embodiment of the present invention allows the user to adjust the workspace for structuring the promotional coupon templates 103. Thus, if desired, the user can zoom in on the overall layout and print regions of promotional coupon templates 103 to closely view and modify the overall layout and print regions. This feature also permits users to zoom out to view the overall layout and print regions of promotional coupon templates 103.

In another system in accordance with an exemplary embodiment of the present invention, after the gaming or other business establishment defines the print regions for the promotional coupon template, a promotional coupon template is stored in a document. The document contains multiple lines. Each line contains a command and the associated parameters required to use that promotional coupon template. The document is stored on a host system and may be incorporated into a new or existing promotion 111. The data may also be transmitted to, stored in, and used by printer 108 either alone or with other promotional coupon templates 103 to generate promotional coupons 104. The data may also be transmitted to and stored in a routing device 109 coupled to printer 108, with routing device 109 transmitting the stored data to printer 108 to generate promotional coupons 104.

One system in accordance with an exemplary embodiment of the present invention allows the overall layout and print regions of promotional coupon templates 103 to be edited or deleted. The parameters for a print region which can be edited include region ID, region data, region size, object ID, object rotation, object width, object justification, object attributes, print attributes, and print color among others.

In addition, one system in accordance with an exemplary embodiment of the present invention allows the export of promotional coupon templates 103 and data for promotional coupons 104, promotions 111, and promotional campaigns 118 for incorporation and use by external software applications such as a casino management system or player tracking system.

Furthermore, another system in accordance with an exemplary embodiment of the present invention provides various methods of establishing communications with printer 108 for data transmission. In one aspect of such a system, when a gaming or other business establishment desires to set up the communication port to which data is transmitted to printer 108, the communication port settings are displayed. A gaming or other business establishment selects the communication port and the communication protocol baud rate, identifies the polling option and command, and initializes the communication port. In addition, a gaming or other business establishment can locate additional communication ports to which to establish communications with printer 108 or routing device 109.

In another aspect of a system in accordance with an exemplary embodiment of the present invention, when a gaming or other business establishment desires to set up the respective communication ports to which gaming or vending vouchers and promotional coupon data is transmitted to printer 108, the communication ports settings are displayed. A gaming or other business establishment selects a gaming or vending voucher file, selects the communication port and the communication protocol baud rate, and initializes the communication port for the gaming or vending voucher. A gaming or other business establishment repeats this process for a promotional coupon.

A gaming or other business establishment can also set the delay between print option which sets the delay print time between printing a gaming or vending voucher 122 and printing promotional coupons 104. A gaming or other business establishment can also disconnect the communication port for the gaming or vending voucher, the promotional coupon, or both.

When a gaming or other business establishment desires to view the parameters of a print job prior to sending a data to a printer, print job controls are displayed. A gaming or other business establishment can select options such as manually sending the print job, sending all print jobs without delay, sending all print jobs with delay, canceling a print job, and clearing the output log that is created when a print job is sent to printer 108.

A gaming or other business establishment can also view the status of printer 108. When desiring to do so, the printer status displays. A gaming or other business establishment can view any communication errors, such as Universal Asynchronous Receiver Transmitter (UART) errors, view the printer library, and reset printer 108 if necessary.

In another system in accordance with an exemplary embodiment of the present invention, data for promotional campaigns 118 which may be transmitted to printer 108 from a host system, stored in, and used by printer 108 to generate a promotional coupon or a plurality of promotional coupons, may be combined with data for promotional coupons 104. In this system, when a gaming or other business establishment desires to create or edit promotional campaigns 118, promotions 111 and promotional campaigns 118 are defined as displays. After a gaming or other business establishment creates or edits promotional campaigns 118, the system inserts a header in a promotional campaign data file 118 which identifies a promotional campaign. The system also calculates a signature, such as a CRC, based on the contents of the promotional campaign data and sends the signature to printer 108.

In another aspect of a system in accordance with an exemplary embodiment of the present invention, a boundary check on the combined promotional coupon templates 103, print regions, graphics and other data which may be included with the promotional campaign 118 data may be performed to ensure conformance with the resources and load requirements of printer 108. In this system, after a gaming or other business establishment transmits data to printer 108, the promotional couponing system performs the boundary check by determining the number of promotional coupon templates 103, print regions, graphics and other data which may be included with promotional campaign 118 data. The promotional couponing system then verifies the signature. After successful verification of the signature, the promotional couponing system loads the data for each promotional coupon template and sends the signature to printer 108.

In another aspect of a system in accordance with an exemplary embodiment of the present invention, data for promotional coupon templates, promotions, and promotional campaigns are stored in the memory of printer 108. In this system, the promotional couponing system transmits the data for promotional coupon templates, promotions, and promotional campaigns to printer 108. When all parameters of promotions 111 or promotional campaigns 118 are met, the printer uses the data stored in memory to generate promotional coupons 104.

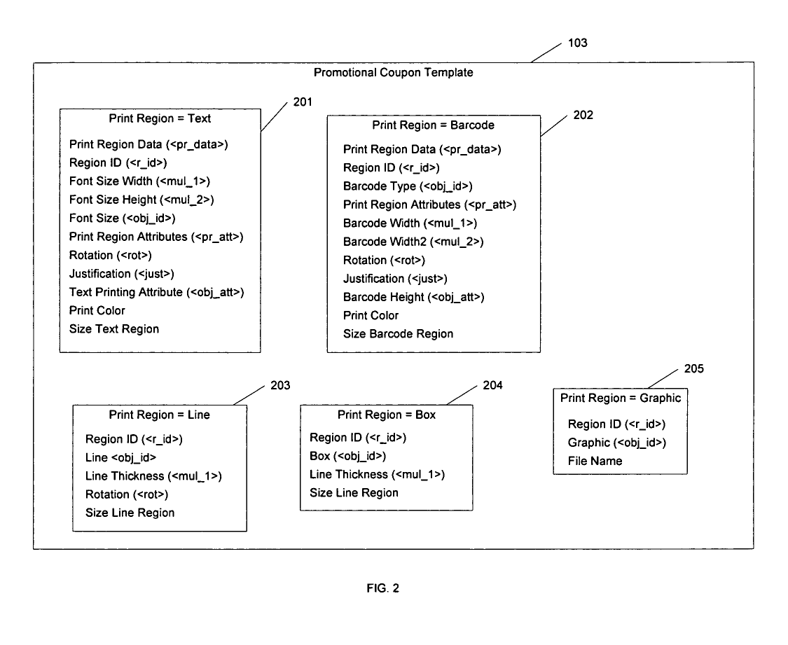

FIG. 2 is an illustration of the attributes of the print regions of promotional coupon template 103 in accordance with an exemplary embodiment of the present invention.

As illustrated, a promotional coupon template may include text print regions 201, barcode print regions 202, line print regions 203, box print regions 204, and graphic print regions 205.

The attributes for text print region 201 are defined in Table I as follows:

TABLE I

| Attribute | Description |
|---|---|
| Print Region Data | Permanently stored data. Can modify if<pr_att> = |
| (<pr_data>) | dynamic, incrementing, or decrementing |
| Region ID (<r_id>) | Print Region identifier. Unique alphanumeric |
| | character |
| Font Size Width | The width of the size of the font. |
| (<mul_1>) | |
| Font Size Height | The height of the size of the font. |
| (<mul_2>) | |
| Font Size | An object identifier which describes the size of the |
| (<obj_id>) | font. |
| Print Region | Special handling instructions for the print region. |
| Attributes | Options for text include: Dynamic, Stored, |
| (<pr_att>) | Incrementing, or Decrementing. |
| Rotation (<rot>) | Rotation of strings or data with the print region. |
| | Options include: 0, 90, 180, or 270 Degrees. |
| Justification | Justification of data within the print region. |
| (<just>) | Options include: Left, Right, or Center. |
| Text Printing | Special handling instructions for the print object. |
| Attribute | Options for text include: Normal or Inverse. |
| (<obj_att>) | |
| Print Color | Color of the print region. |
| Size Text Region | Sizing for the print region. Shrink/Enlarge Width |
| | and Height. |

The attributes for barcode print region 202 are defined in Table II as follows:

TABLE II

| Attribute | Description |
|---|---|
| Print Region Data | Permanently stored data. Can modify if<pr_att> = |
| (<pr_data>) | dynamic, increment, or decrement |
| Region ID (<r_id>) | Print Region identifier. Unique alphanumeric |
| | character. |
| Barcode Type | An object identifier which describes the type of |
| (<obj_id>) | barcode used. |
| Print Region | Special handling instructions for the print region. |
| Attributes | Options for barcodes include: Dynamic, Stored, |
| (<pr_att>) | Increment, or Decrement. |
| Barcode Width | The first width of the barcode. |
| (<mul_1>) | |
| Barcode Width2 | The second width of the barcode. |
| (<mul_2>) | |
| Rotation | Rotation of strings or data with print region. |
| (<rot>) | Options include: 0, 90, 180, or 270 Degrees. |
| Justification | Justification of data within print region. Options |
| (<just>) | include: Left, Right, or Center. |
| Barcode Height | The height of the barcode. |
| (<obj_att>) | |
| Print Color | Color of the print region. |
| Size Barcode | Sizing for the print region. Shrink/Enlarge Width |
| Region | and Height. |

The attributes for line print region 203 are defined in Table III as follows:

TABLE III

| Attribute | Description |
|---|---|
| Region ID | Print Region identifier. Unique Alphanumeric |
| (<r_id>) | Character. |
| Line (<obj_id>) | An object identifier which describes a line. |
| Line Thickness | The thickness of the line. |
| (<mul_1>) | |
| Rotation (<rot>) | Rotation of strings or data with print region. Options |
| | include: 0, 90, 180, or 270 Degrees. |
| Size Line Region | Sizing for the print region. Shrink/Enlarge Width and |
| | Height |

The attributes for box print region 204 are defined in Table IV as follows:

TABLE IV

| Attribute | Description |
|---|---|
| Region ID | Print Region identifier. Unique Alphanumeric |
| (<r_id>) | Character. |
| Box (<obj_id>) | An object identifier which describes a box. |
| Line Thickness | The thickness of the line. |
| (<mul_1) | |
| Size Box Region | Sizing for the print region. Shrink/Enlarge |
| | Width and Height |

The attributes for graphic print region 205 are defined in Table V as follows:

TABLE V

| Attribute | Description |
|---|---|
| Region ID | Print Region identifier. Unique Alphanumeric Character. |
| (<r_id>) | |
| Graphic | An object identifier which describes a graphic. |
| (<obj_id>) | |
| File Name | Name of the graphic file. |

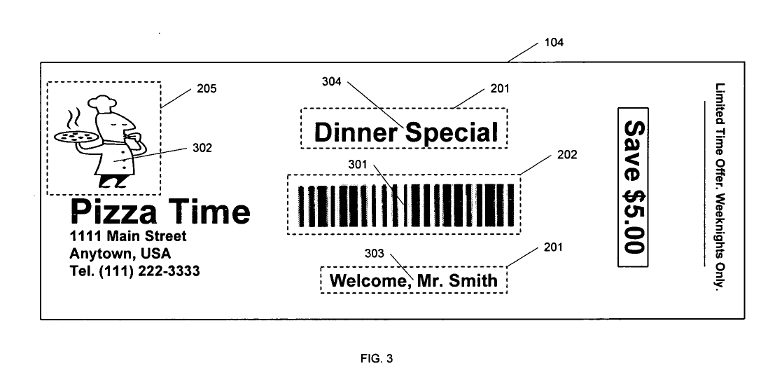

FIG. 3 is an illustration of an exemplary promotional coupon 104 including logical fields in accordance with an exemplary embodiment of the present invention. In this example, promotional coupon 104 may include five types of print regions: text, barcode, graphic, line, and box as described in FIG. 3. The print regions of a promotional coupon template used to create this example are defined in the promotional couponing system and may be stored in a printer, such as printer 108. The template may include a plurality of print regions in combination, resulting in a paste-up style printed coupon.

The actual value of data for each print region may or may not be included in the promotional coupon template. For example, a promotional coupon template may include a barcode field 202 for printing a barcode 301. However the actual value of the barcode is transmitted to printer 108 at the time promotional coupon 104 is generated using promotional coupon template 103. In this way, promotional coupon 104 may have print regions that include static data, such as a graphic 302 in graphic print region 205, or dynamic data such as the name 303 of a particular patron in a text print region 201. In this way, customized promotional coupons may be printed by printer 108 without transferring large amounts of data through a communications network coupling printer 108 to a master promotional controller.

In addition, data that is used to track usage of promotional coupons may be included in promotional coupon 104. For example, a barcode field 202 or a text field 201 may be used to print a barcode value 301 or text string 304 uniquely identifying promotional coupon 104. In this way, printer 108 creates an image of a barcode or barcodes, characters or marks that may be read by a gaming or vending machine bill acceptor on the same or another gaming or vending machine, allowing automatic acceptance of promotional coupons.

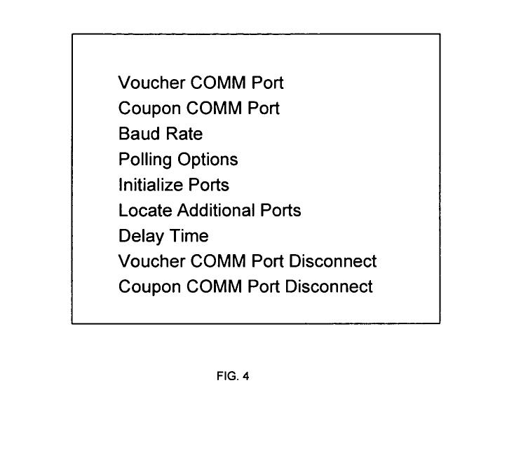

FIG. 4 is an illustration of the attributes of the communication settings with printer 108 in accordance with an exemplary embodiment of the present invention. The following describes each attribute. Voucher COMM Port is used to identify the communication port used for voucher printing. Coupon COMM Port is used to identify the communication port used for promotional coupon printing. Baud Rate is used to set the data transmission rate for the Voucher COMM port and the Coupon COMM port. Polling Options are used on the Voucher COMM Port and the Coupon COMM port to poll the printer status. During polling, the status of the printer is sent to the promotional couponing system.

Initialize Ports is used to set up each port for data transmission. Locate Additional Ports is used to find other ports which may be available on a printer. Delay Time is used to set the time to delay printing of a voucher and a promotional coupon. Voucher COMM Port Disconnect is used to disconnect communication with the Voucher COMM Port. Coupon COMM Port Disconnect is used to disconnect communication with the Coupon COMM Port.

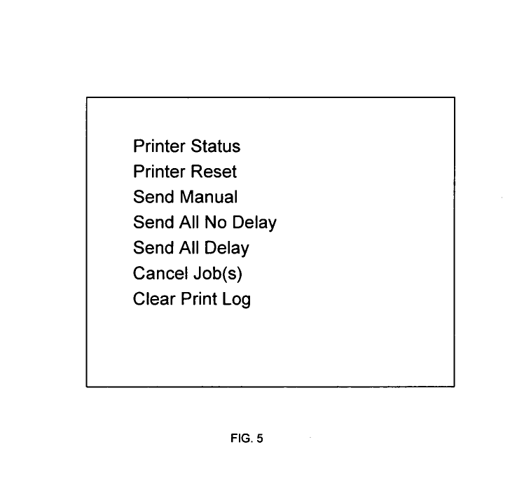

FIG. 5 is an illustration of the attributes of the printer settings in accordance with an exemplary embodiment of the present invention. The following describes each attribute. Printer Status is used to determine the status of the printer. Printer Reset is used to reset the printer should an error occur. Send Manual is used to manually send each print job to the printer. Send All No Delay is used to send all print jobs to the printer without delaying any of the print jobs. Send All Delay is used to send all print jobs to the printer using the Delay Time attribute of FIG. 4. Cancel Job(s) is used to cancel all print jobs currently queued to the printer. Clear Print Log is used to clear the file which logs each print job.

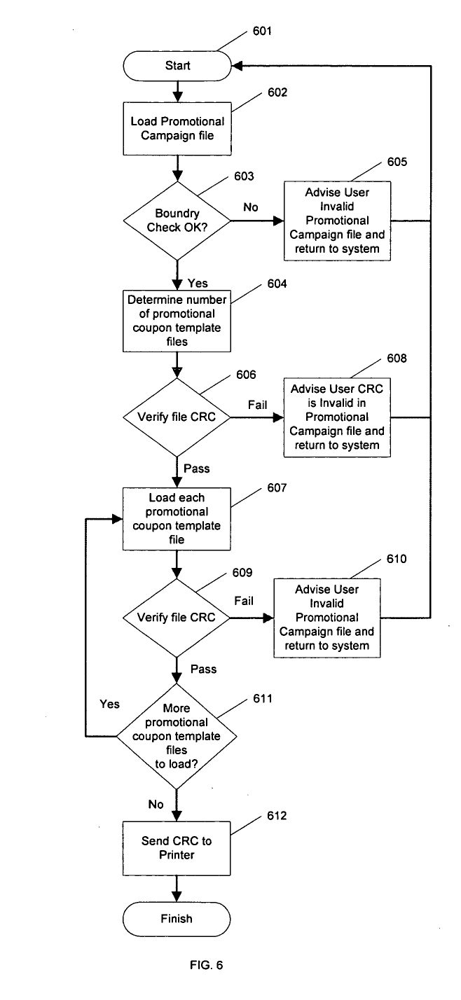

FIG. 6 is a flow chart of the load, check, and verify CRC process for a promotional campaign in accordance with an exemplary embodiment of the present invention.

As illustrated, the process begins (601) with loading (602) promotional campaign data. A boundary check is performed (603). If the promotional campaign data passes the boundary check, the process continues with determining (604) the number of promotional coupon template files. If the promotional campaign data does not pass the boundary check, the system advises (605) the user and returns to the promotional couponing system.

After determining the number of promotional coupon template files, a verify file CRC is performed (606) on the promotional campaign data. If the promotional campaign data passes the CRC verification, the process continues with the loading (607) of each promotional coupon template. If the promotional campaign data does not pass the CRC verification, the system advises (608) the user and returns to the promotional couponing system.

After loading each promotional coupon template, a verify file CRC is performed (609) on each promotional coupon template in the promotional campaign data. If the promotional campaign data does not pass the CRC verification, the system advises (610) the user and returns to the promotional couponing system. If the promotional campaign data passes the CRC verification, the process determines (611) whether there are additional promotional coupon templates to load. If there are additional promotional coupon templates to load, the process returns to 607. If there are no additional promotional coupons to load, the process advances to 612.

At 612, after loading all promotional coupon templates is complete, the process completes with the CRC being sent (612) to the printer.

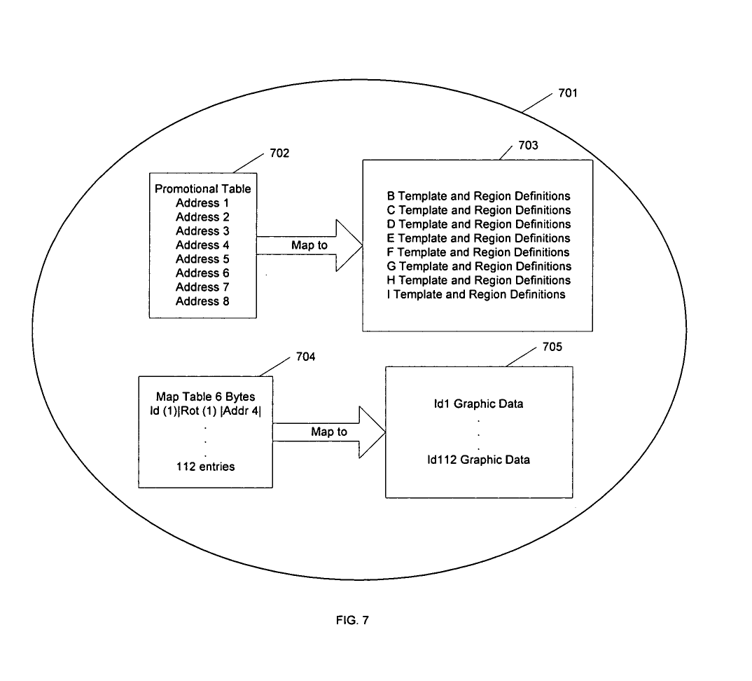

FIG. 7 is an illustration of the data stored in the memory of printer 108 in accordance with an exemplary embodiment of the present invention.

As illustrated, a printer memory 701 comprises a promotional table 702, template and region definitions 703, and graphics. The promotional table comprises one or a plurality of addresses. Each address is mapped to a template and region definition. A map table 704 comprises 6 bytes of graphic data as follows: 1 byte for the object identification (ID), 1 byte for the object rotation (Rot); and 4 bytes for the object address (Addr). In this example, the map table may contain a total of 112 entries. Each entry is mapped to graphic data 705 in memory.

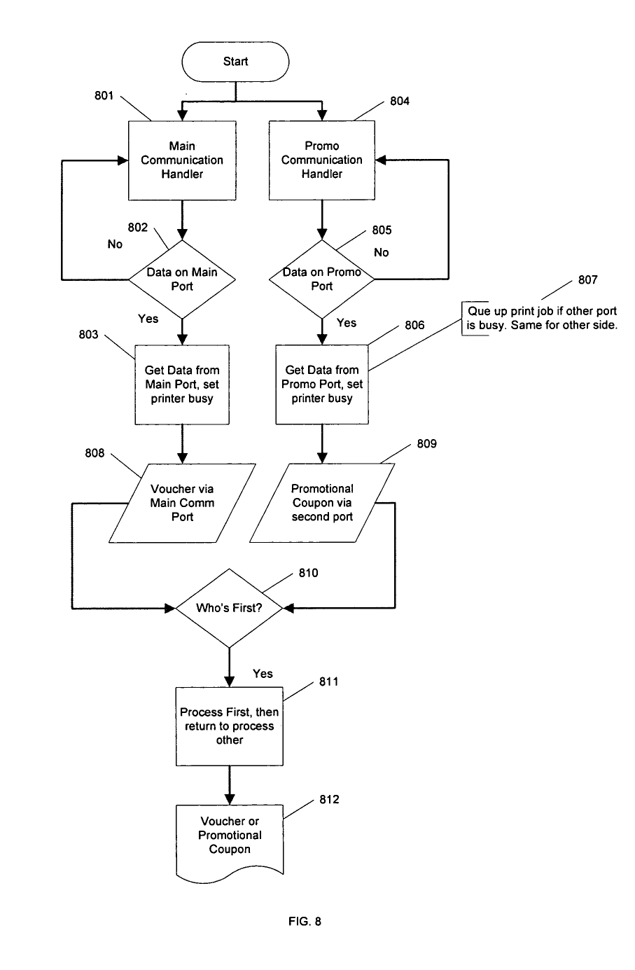

FIG. 8 is a process flow diagram for gaming and vending vouchers and promotional data in a gaming environment in accordance with an exemplary embodiment of the present invention.

As illustrated, the process for vouchers begins with a Main Communication Handler 801. A determination is made (802) whether data exists on the main port. If data, such as a voucher 808, exists on the main port, the system gets (803) the data from the main port and sets the printer to busy. If data does not exist on the main port, the process returns to Main Communication Handler 801.

The process for promotional coupons begins with a Promo Communication Handler 804. A determination is made (805) whether data exists on the promo port. If data, such as a promotional coupon 104, exists on the promo port, the system gets (806) the data 809 from the promo port and sets the printer to busy. If data does not exist on the promo port, the process returns to Promo Communication Handler 804.

If the printer is busy using any port, the data from the other port is queued (807).

The process continues with the system identifying (810) which data was received first. Because the process begins with Main Communication Handler 801 determining whether voucher data exists on the main port, if voucher data exists on the main port the voucher data will be identified at 810 as being received first. After identifying the data received first, the system processes (811) the first data to generate a voucher or promotional coupon, then returns to process the second data to generate (812) a voucher or promotional coupon.

In one embodiment, identifying which data was received first is based on a priority. For example, priority can be given to voucher data in the event that voucher data exists on the main port and promotional coupon data exists on the promo port. In another embodiment, priority can be given to voucher data such that even when promotional coupon data is received first, the system waits to receive and print corresponding voucher data prior to printing the promotional coupon data.

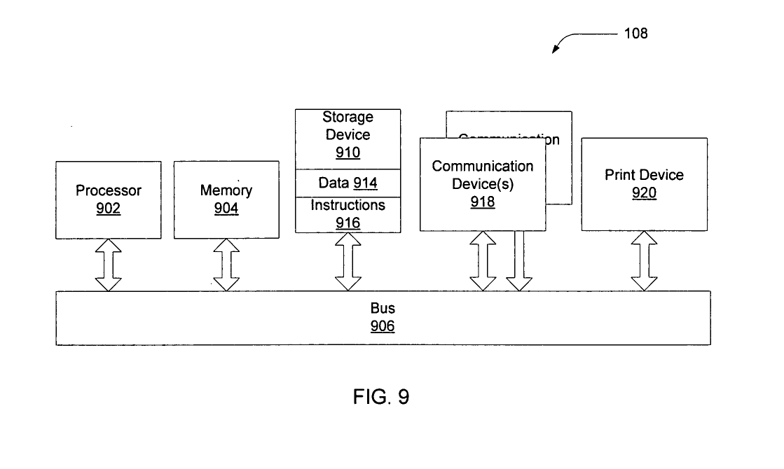

FIG. 9 is a block diagram of an external device such as a printer in accordance with an exemplary embodiment of the present invention. A printer 108 includes a processor 902, operatively coupled via a bus 906 to a memory 904. The processor is further operatively coupled via the bus to a storage device 910. Program instructions 916 and data 914 implementing previously described voucher and coupon printing processes are stored in the storage device until the processor retrieves the program instructions and stores them in the memory. The processor then executes the program instructions stored in the memory and uses the data to implement the features of the printer as previously described.

The processor is further coupled via the bus to one or more communication devices or ports 918. The printer uses the communication devices to transmit and receive control signals from a promotion generation system, gaming system or gaming machine as previously described.

The processor is further coupled via the system bus to a print device 920. The printer uses the print device to generate vouchers coupons as previously described.

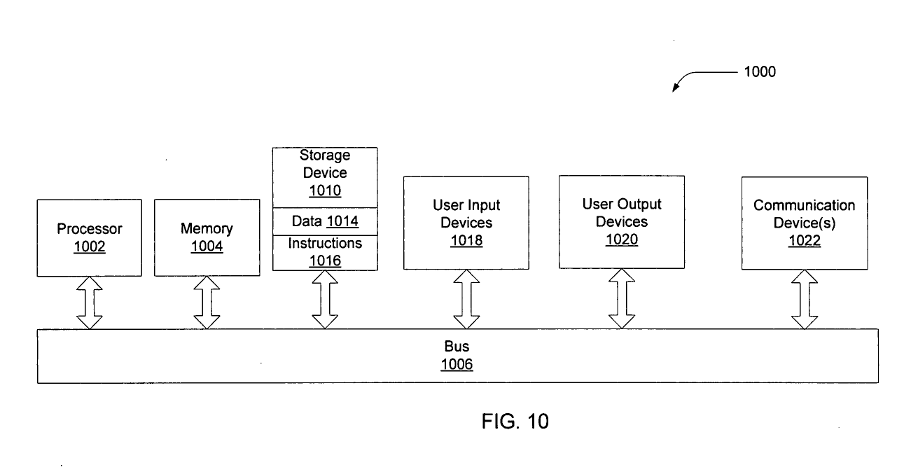

FIG. 10 is a block diagram of a host system for hosting a process for creation of a promotion in accordance with an exemplary embodiment of the present invention. A host 1000 includes a processor 1002, operatively coupled via a bus 1006 to a memory 1004. The processor is further operatively coupled via the bus to a storage device 1010. Program instructions 1016 and data 1014 for implementing the previously described promotional program generation processes are stored in the storage device until the processor retrieves the program instructions and stores them in the memory. The processor then executes the program instructions stored in the memory and uses the data to implement the features of the promotional program generation processes as previously described.

The processor is further coupled via the bus to one or more communications devices or ports 1022. The host uses the communications devices to transmit and receive control signals to and from external devices as previously described.

The processor is further coupled via the bus to one or more user input devices 1018 and one or more user output devices 1020 for communicating with a user as previously described in order to create a promotional program.

Although the present invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

### APPENDIX A—LIST OF TERMS

“Gaming Establishment”—a gaming entity, such as a casino.

“Business Establishment”—a business entity, which may use a kiosk for consumer purchases such as movie tickets, parking tickets, venue tickets, etc., or a retail business entity.

“Host System”—includes a server, a personal computer connected to a network, and a stand alone personal computer which is used for application and data storage, data processing, and file transfers.

“CRC”—a mathematical formula used as a signature for the binary image of the firmware or data included in the sectional memory of a printer. Acronym for Cyclic Redundancy Check.

“Printer”—a printing device, which may be located within a cashless enabled game, a vending machine or kiosk, or coupled to a point-of-sale system.

“Print Region”—a print object, such as text, barcode, line, box, or graphic, which may be used on a template which describes where to put the print object on a coupon or voucher, how to print the print object, the orientation of print (0, 90, etc.), and other special control factors.

“Template”—includes a collection of Print Regions referenced by a single identification byte that is used to format the positioning of Print Regions on a coupon or voucher.

What is claimed is:

1. A method of promotional couponing comprising:
displaying a promotional coupon template to a user;
defining a layout of the promotional coupon template, including placing a print region on the promotional coupon template;
defining a trigger by which a promotional coupon will be generated from the promotional coupon template by an external device; and
transmitting the promotional coupon template to the external device.

2. The method of claim 1, wherein defining the layout further includes defining parameters for the print region.

3. The method of claim 1, wherein parameters for the print region are selected from the group comprising a region identification, a region data, a region size, an object identification, an object rotation, an object width, an object justification, an object attribute, a print attribute, and a print color.

4. The method of claim 1, wherein the print region is selected from the group comprising a barcode region, a text region, a line region, a box region, and a graphic region.

5. The method of claim 1, further comprising:
generating a second promotional coupon template based on the promotional coupon template.

6. The method of claim 1, wherein the external device is a printer, and the method further comprises:
generating a promotional coupon by the printer based on the trigger.

7. The method of claim 1, wherein the external device is a routing device that is connected to a printer, and the method further comprises:
transmitting the promotional coupon template from the routing device to a printer based on the trigger; and
generating a promotional coupon by the printer.

8. The method of claim 1, wherein the trigger is selected from the group comprising amount wagered, amount lost, rate of play, length of play, issuance per trigger, birthday, frequency selector, and issue period.

9. The method of claim 1, further comprising:
defining a promotion, including defining parameters for the promotion; and
transmitting the promotion to the external device.

10. The method of claim 9, wherein the parameters for the promotion are selected from the group comprising a promotion start date, a promotion end date, a promotion ending period based on a number of issued coupons, a promotion start time, a promotion end time, an issuing name for the promotion, a trigger, and a promotional coupon template for use with the promotion.

11. The method of claim 9, further comprising:
defining a promotional campaign, including defining parameters for the promotional campaign, associating the promotion with the promotional campaign, assigning a name to the promotional campaign, and associating the promotional coupon template with the promotional campaign.

12. The method of claim 11, wherein the parameters for the promotional campaign are selected from the group comprising a promotional campaign name, a promotion association, and a type of promotional campaign.

13. A promotional couponing apparatus comprising:
a display that displays a promotional coupon template;
an editor that edits a layout of the promotional coupon template, including placing a print region on the promotional coupon template and defining a trigger by which a promotional coupon will be generated from the promotional coupon template by an external device; and
a transmitter that transmits the promotional coupon template to the external device.

14. A computer-readable medium storing a computer-executable program executable to perform the process of claim 1.

15. A method of printing a voucher and a promotional coupon, comprising:
receiving voucher data of the voucher on a first port;
receiving promotional coupon data of the promotional coupon corresponding to the voucher on a second port;
determining a first data and a second data based on a priority between the voucher data and the promotional coupon data;
printing the first data; and
queuing the second data.

16. The method of claim 15, wherein the priority is assigned to the voucher such that when voucher data is received on the first port and promotional coupon data is received on the second port, the voucher data is determined as the first data and the promotional coupon data is determined as the second data.

17. The method of claim 15, wherein the priority is assigned to voucher data such that the voucher data is determined as the first data and the promotional coupon data is determined as the second data, even when the promotional coupon data is received on the second port before the voucher data is received on the first port.

18. A method of printing a voucher and a promotional coupon, comprising:
receiving voucher data of the voucher on a first port;
printing the voucher when the voucher data is received;
receiving promotional coupon data of the promotional coupon corresponding to the voucher on a second port;
determining whether the voucher corresponding to the promotional coupon data has been printed;
queuing the promotional coupon data if the corresponding gaming coupon has not been printed; and
printing the promotional coupon if the corresponding gaming coupon has been printed.

19. An apparatus for printing a voucher and a promotional coupon, comprising:
a voucher receiver that receives voucher data of the voucher on a first port;
a promotional coupon receiver that receives promotional coupon data of the promotional coupon corresponding to the voucher on a second port;
a determiner that determines a first data and a second data based on a priority between the voucher data and the promotional coupon data;
a printer that prints the first data; and
a queue in which the second data is queued.

20. A computer-readable medium storing a computer-executable program executable to perform the process of claim 15.
